(19) United States
(12) Patent Application Publication
(10) Pub. No.: US 2007/0005433 A1
(43) Pub. Date: Jan. 4, 2007

(54) Method and system for advertisement related to information service

(76) Inventors: Hwa Seop Lee, Yongin-si (KR); Mi Jeong Choi, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/515,710

(22) Filed: Sep. 5, 2006

Related U.S. Application Data
(63) Continuation of application No. PCT/KR05/00598, filed on Mar. 4, 2005.

(30) Foreign Application Priority Data
Mar. 4, 2004 (KR) 10-2004-0014523

(51) Int. Cl. G06Q 30/00

(52) U.S. Cl. 705/14

(57) ABSTRACT

The present invention relates to a knowledge advertising method and a knowledge advertising system, and more particularly, relates to a knowledge advertising method and a knowledge advertising system using a knowledge service which enables users to be provided with knowledge through questions and answers between users.

### CROSS-REFERENCE TO RELATED APPLICATIONS

This application is a continuation of International Patent Application No. PCT/KR2005/000598, filed on Mar. 4, 2005, which claims priority to Korean Patent Application No. 10-2004-0014523, filed on Mar. 4, 2004. International Application No. PCT/KR2005/000598 was published in English as WO 2005/086052 on Sep. 15, 2005. Both International Patent Application No. PCT/KR2005/000598 including its publication and Korean Patent Application No. 10-2004-0014523 are incorporated herein by reference in their entirety.

### BACKGROUND OF THE INVENTION

1. Field of the Invention

The present invention relates to a knowledge advertising method and a knowledge advertising system, and more particularly, relates to a knowledge advertising method and a knowledge advertising system using a knowledge service which enables users to be provided with knowledge through questions and answers between users.

2. Description of the Related Art

Advertising goods or services by using a network, particularly the Internet, becomes our daily activities. Together with this, Internet advertising services that enable advertisements with respect to goods or services on a web site such as a portal site and the like, and that charge a distributor of the goods or services predetermined fees, are performed in a variety of methods.

One of Internet advertising service methods according to the prior art is to allow a banner advertisement on the web site. This method enables a banner consisting of advertising messages or advertising images to be displayed on a predetermined location of the web page, and adopts a method of charging the distributor based on the number of expressions of the banner, the number of clicks of the banner by a user, and the like. These days, the image data are generated into a type of Animated GIF or flash, or generated by using a program language such as java and the like. Thus, it is general to employ a method of using a banner comprising dynamic images.

In addition, another Internet advertising service method according to the prior art is to allow an inserting advertisement. This method transmits advertisement data to a user terminal while a predetermined web page is loading thereto at the user's request, thereby enabling the advertisement data to be displayed on the user's terminal. Moreover, this method adopts a method of charging the distributor based on the number of transmissions of the advertisement data. In many cases, this method enables the advertisement data to be displayed by using a front surface of indicator of user terminal while the web page is loading. Therefore, there is an advantage that it is highly possible to obtain the user's attention. On the other hand, there is a disadvantage that it is possible to offend the user because an advertisement expression is compulsory and loading of the web page is delayed until transmission of the advertisement data is completed.

Furthermore, another Internet advertising service method according to the prior art is to allow a keyword advertisement. In case that a user inputs a predetermined keyword to use a search service, this method provides a list of search results with respect to the keyword, and puts the web page of a distributor who has paid fees in a higher rank of the search result list. This method adopts a method of charging the distributor based on the number of expressions of the search results, the number of accesses to the web page, and the like.

Besides the aforementioned Internet advertising service methods, there are being used a variety of Internet advertising service methods. Moreover, there are being conceived a variety of Internet advertising service methods in order to enhance both advertisement effects and advertisement orders from advertisers.

### SUMMARY OF THE INVENTION

The present invention provides a knowledge advertising method and a knowledge advertising system associated with a knowledge service. Namely, the present invention provides the knowledge advertising method and the knowledge advertising system, enabling answerers to give advertising answers including predetermined advertising information with respect to questions inputted by users in the knowledge service.

The present invention also provides a knowledge advertising method and a knowledge advertising system, capable of enhancing attention of users by providing users the advertising answers by a method different from that of providing an ordinary answer (hereinafter, ‘general answer’).

The present invention also provides a knowledge advertising method and a knowledge advertising system, capable of giving an advertiser a right to give an advertising answer and charging the advertiser advertisement costs with respect to the grant of the right.

The present invention also provides a knowledge advertising method and a knowledge advertising system, enabling an advertiser to give an advertising answer during a certain period or as many as a certain number of times.

The present invention also provides a knowledge advertising method and a knowledge advertising system, capable of determining the advertisement costs based on the certain period or the certain number of times.

The present invention also provides a knowledge advertising method and a knowledge advertising system, capable of giving a right for giving an advertiser an advertising answer in accordance with each category.

The present invention also provides a knowledge advertising method and a knowledge advertising system, capable of measuring an activation degree of a category, i.e. preferences of users with respect to the category and determining the advertisement costs in accordance with the measured activation degree.

The present invention also provides a knowledge advertising method and a knowledge advertising system, capable of controlling users to be linked to a predetermined webpage through the advertising answer and charging the advertiser advertisement costs with respect to providing of the link.

The present invention also provides a knowledge advertising method and a knowledge advertising system, capable of determining the advertisement costs with respect to providing of the link on the basis of a link number, which is a number of times that a user accesses the webpage through the advertising answer.

In order to achieve the above objects and solve the aforementioned problems in the prior art, the present invention comprises the steps of: maintaining a knowledge advertisement database including a knowledge advertisement record, wherein the knowledge advertisement record includes a category and an advertiser identifier for identifying an advertiser associated with the category; providing users with question information received from a user in accordance with each category, through a wired/wireless communication network; receiving answer information with respect to question information belonging to a first category, from an advertiser; searching the knowledge advertisement database for a second category associated with the advertiser; in case that the first category is identical to the second category, allocating an advertisement identifier to the answer information, thereby generating advertising answer information; and providing the user with the advertising answer information through the wire/wireless communication network, by a method different from that of providing general answer information without the advertisement identifier.

### BRIEF DESCRIPTION OF THE DRAWINGS

FIG. 1 is a view illustrating a network connection of a knowledge service system providing a knowledge service.

FIG. 2 is a view illustrating one example of knowledge information that a knowledge service system provides users through a predetermined webpage.

FIGS. 3 and 4 are flowcharts illustrating a knowledge advertising method according to one embodiment of the present invention.

FIG. 5 is a view illustrating one example of data recorded in a knowledge advertisement database according to one embodiment of the present invention.

FIG. 6 is a view illustrating one example of advertising answer information provided for a user according to one embodiment of the present invention.

FIG. 7 is a flowchart for explaining procedures of registering an advertiser identifier in a knowledge advertisement database by each category.

FIG. 8 is a block diagram illustrating a knowledge advertising system according to another embodiment of the present invention.

FIG. 9 is a view for explaining advertising answer information according to anther embodiment of the present invention.

FIG. 10 is an internal block diagram of a general-purpose computer which may be adopted in a knowledge advertising method according to the present invention.

### DETAILED DESCRIPTION OF THE PREFERRED EMBODIMENT

Hereinafter, the present invention will be described fully with reference to the accompanying drawings.

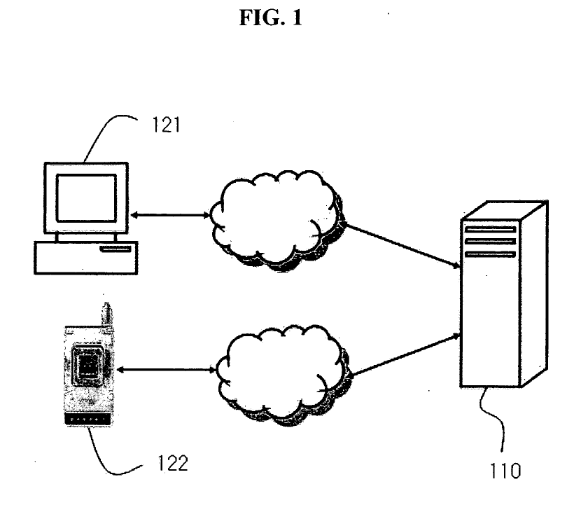

A knowledge service which may employ a knowledge advertising method of the present invention will be described with reference to FIG. 1. FIG. 1 is a view illustrating a network connection of a knowledge service system providing the knowledge service. In the meantime, the knowledge service system described in the present specification is only exemplary and it will be apparent that the present invention may be applied to all sorts of knowledge service systems that perform knowledge services, providing users with knowledge through questions and answers therebetween.

A knowledge service system 110 receives question information from a user 121, and records and maintains the received question information in a predetermined knowledge database. In addition, the knowledge service system 110 provides users with the question information by displaying the same on a predetermined web page. The user 122 who has been provided with the question information, may input answer information with respect to the question information in the knowledge service system 110. The answer information is displayed on the web page in association with the question information. The knowledge service system 110 records the answer information in the knowledge database in association with the question information, and maintains both the question information and the answer information as knowledge information.

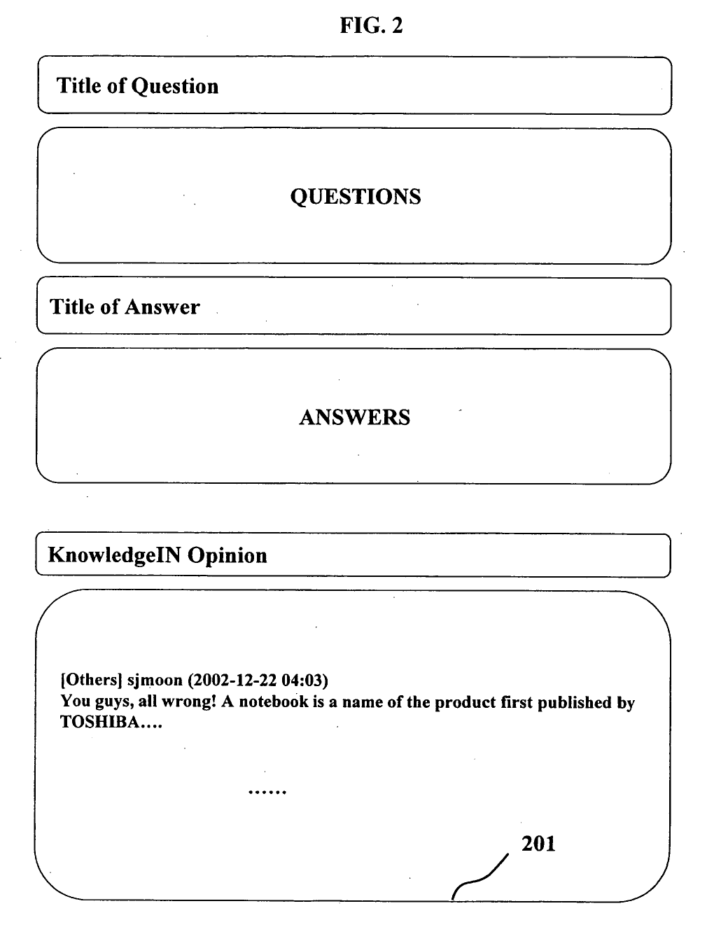

Accordingly, the user 121 may be provided with an answer to his/her own question and even other users who have not inputted the question information directly may be provided with variety of knowledge through the web page. FIG. 2 is a view illustrating one example of knowledge information that the knowledge service system 110 provides users through the web page. The knowledge information includes question information and answer information. The knowledge service system 110 may display opinion information inputted by a questioner (a user who inputs question information), an answerer (a user who inputs answer information), or other users besides the questioner and the answerer, as indicated by a drawing symbol 201, in accordance with a type of services. In the meantime, the knowledge information may be provided by various methods, besides the method of displaying the knowledge information on the web page, such as a method of providing the user with the knowledge information by wirelessly transmitting the same through a wireless terminal, etc.

In addition, the knowledge service system 110 provides a search service, enabling users 121 and 122 to search for a variety of knowledge information maintained and accumulated in the knowledge database. As the time goes by, an amount of knowledge information accumulated in the knowledge database has no choice but to be enlarged. Thus, it is preferable to provide a search service so that users may be provided with knowledge information that they want.

The search service may be performed by a keyword searching method or a category searching method. As for example, the present embodiment describes that the knowledge service system 110 provides the search service by using both the keyword searching method and the category searching method. A knowledge advertising method according to the present embodiment may be performed in a knowledge advertising system installed in the knowledge service system 110 or interoperating therewith 110.

“Advertising answer information” used in the present specification is answer information to which an advertisement identifier is allocated among answer information with respect to predetermined question information, and ‘general answer information’ is answer information to which the advertisement identifier is not allocated. General advertising answer information includes advertising information for advertising.

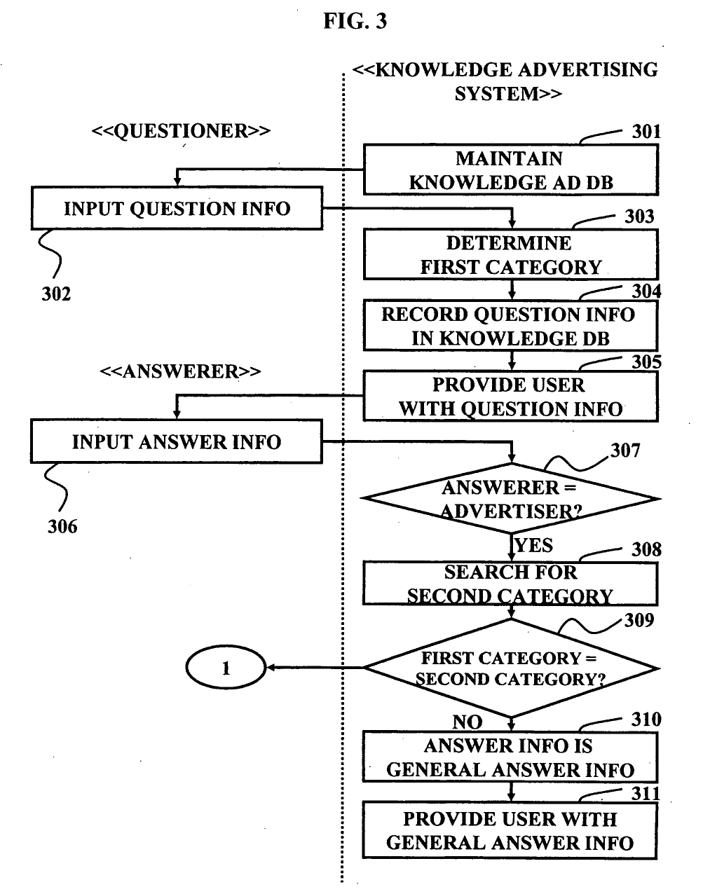

FIGS. 3 and 4 are flowcharts illustrating a knowledge advertising method according to one embodiment of the present invention.

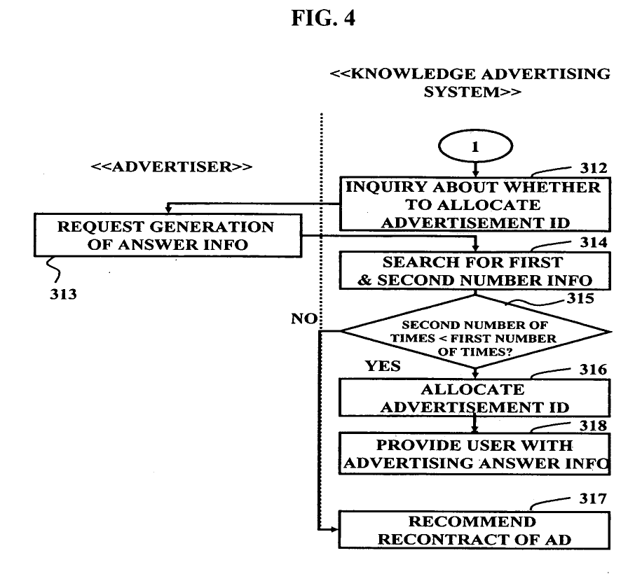

In the step 301, the knowledge advertising system maintains a knowledge advertisement database including a knowledge advertisement record. The knowledge advertisement record includes at least one selected from the group consisting of a category, an advertiser identifier, first number information, second number information, and expiration time information. FIG. 5 is a view illustrating one example of data recorded in the knowledge advertisement database.

The category is a standard for classifying question information or answer information. Thus, the user may input question information into the knowledge advertising system by each category. The advertiser identifier is an identifier for identifying an advertiser who may generate advertising answer information belonging to the category. The first number information, the second number information and the expiration time information will be described later.

The knowledge advertisement database is a database maintaining information associated with an advertiser who has paid (or will pay) certain advertisement costs. Thus, the knowledge advertising system enables an advertisement using advertising answer information to be advertised by referring to the knowledge advertisement database.

According to another embodiment of the present invention, the knowledge advertising system charges the advertiser a first fee in association with registration of the information on the advertiser in the knowledge advertisement database. Configuration in which the knowledge advertising system charges the advertiser the first fee will be described later.

The knowledge advertising system receives question information from a questioner in the step 302, and determines a first category to which the question information belongs in the step 303.

The knowledge advertisement database may employ a method of receiving a selection of the first category from the user in order to determine the first category, a method of determining the first category corresponding to the question information by analyzing the same, or the like. In addition, the knowledge advertisement database may employ the two methods in combination. Moreover, a variety of well-known methods may be employed to determine a category associated with predetermined information.

In the step 304, the knowledge advertising system records and maintains the received question information in a knowledge database, in association with the first category. In the step 305, the knowledge advertising system provides users with the question information through a wired/wireless communication network, in association with the first category.

In the step 306, the user who has been provided with the question information inputs answer information with respect to the question information. At this time, the user who inputs the answer information is an answerer.

In the step 307, the knowledge advertising system determines whether the answerer is an advertiser by referring to the knowledge advertisement database. For example, the knowledge advertising system may determine whether the answerer is an advertiser by searching advertiser identifiers recorded in the knowledge advertisement database for an advertiser identifier that is identical to a user identifier with respect to the answerer.

In the step 308, in case that it is determined that the answerer is an advertiser, the knowledge advertising system searches the knowledge advertisement database for a second category associated with the advertiser. For example, in case that the advertiser is an advertiser of which an advertiser identifier is ‘wisjjang’, the second category associated with the advertiser is ‘a magic’.

In the step 309, the knowledge advertising system determines whether the first category is identical to the second category.

In case that it is determined that the first category is not identical to the second category, the knowledge advertising system determines the answer information as general answer information in the step 310 and provides users with the general answer information through the wired/wireless network in the step 311.

In case that it is determined that the first category is identical to the second category, the knowledge advertising system inquiries the advertiser about whether to allocate an advertisement identifier to the answer information, thereby generating advertising answer information in the step 312.

In the step 313, the advertiser requests the knowledge advertising system to generate the advertisement identifier to the answer information, thereby generating advertising answer information in accordance with the inquiry.

The knowledge advertising system allocates the advertisement identifier to the answer information and thereby, generates advertising answer information in accordance with the request.

In case that the advertiser answers not to allocate the advertisement identifier to the answer information, in response to the inquiry, the knowledge advertising system determines the answer information as general answer information in the step 310 and provides users with the general answer information through the wired/wireless network in the step 311.

In the meantime, according to another embodiment of the present invention, the knowledge advertising system may generate advertising answer information by omitting the steps 312 and 313 and uniformly allocating an advertisement identifier to answer information inputted by the advertiser in association with answer information.

In the meantime, according to another embodiment of the present invention, the knowledge advertising system allows an advertiser to generate advertising answer information only during a predetermined period. For this, the knowledge advertising system searches for expiration time information associated with the advertiser by referring to the knowledge advertisement database.

The knowledge advertising system allocates the advertisement identifier to the answer information, only in case that the expiration time has not passed by using the searched expiration time information.

Furthermore, according to another embodiment of the present invention, a right of enabling an advertiser to generate advertising answer information only during a predetermined period may be embodied as follows. The knowledge advertising system searches for expiration time information recorded in the knowledge advertisement database, regularly or irregularly. In case that it is determined that the expiration time has passed by using the searched expiration time information, the knowledge advertising system deletes the knowledge advertisement record including the searched expiration time information from the knowledge advertisement database. According to configuration so constructed, since the advertiser identifier that is identical to the user identifier with respect to the user has been deleted, the advertiser identifier is not searched in the step 307. Thus, since it is determined that the user is not an advertiser, the advertisement identifier is not allocated to answer information inputted by the user.

Like above, it is described that a period enabling the advertiser to “generate” advertising answer information is limited.

Furthermore, according to another embodiment of the present invention, an existing period is designated with respect to the “generated” advertising answer information. The advertising answer information that has passed the existing period is changed into general answer information and provided for the user by a method of providing general answer information.

The existing period may be associated with the advertiser. At this time, the knowledge advertisement record further includes expiration time information of a contract associated with the advertiser. The expiration time information of the contract is information on the expiration time of the existing period of advertising answer information generated in association with the advertiser.

For example, the expiration time of the contract associated with the advertiser ‘wisjjang’ is ‘0 a.m. 31-Oct.-2004’. The knowledge advertising system determines whether the expiration time of the contract has passed, and in case that it is determined that the expiration time of the contract has passed 0 a.m. 31-Oct.-2004; searches for advertising answer information generated in association with the advertiser ‘wisjjang’.

The knowledge advertising system retrieves the advertisement identifier from the searched advertising answer information and changes the searched advertising answer information into general answer information. Moreover, the knowledge advertising system provides users with the answer information changed into the general answer information, by a method of providing general answer information.

Furthermore, the existing period may be associated with each of advertising answer information. Accordingly, in case that the existing period associated with each of advertising answer information passes, the advertising answer information is changed into general answer information, respectively. In this case, in the step 316, the knowledge advertising system allocates the advertisement identifier to answer information received from the advertiser and generate advertising answer information including the answer information to which the advertisement identifier is allocated and second expiration time information associated with the answer information. The second expiration time information is information on expiration time of existing period associated with each of advertising answer information respectively.

For example, in case that it is set that the date when the answer information is inputted is 3 p.m. 1-Mar.-2004 and the existing period of advertising answer information is one year, respectively, the second expiration time is 3 p.m. 1-Mar.-2005.

The knowledge advertising system determines whether the second expiration time of advertising answer information has passed (i.e. whether the existing period of the advertising answer information has passed) using second expiration time information included in the advertising answer information, respectively.

In case that it is determined that the second expiration time of the advertising answer information has passed, for example, in case that it has passed 3 p.m. 1-Mar.-2005, the knowledge advertising system retrieves the advertisement identifier from the searched advertising answer information and changes the searched advertising answer information into general answer information. Moreover, answer information changed into general answer information is provided for users by a method of providing general answer information.

Furthermore, according to another embodiment of the present invention, the number of times that an advertisement identifier may be allocated to answer information inputted by the advertiser is limited. For this, in the step 314, the knowledge advertising system searches the knowledge advertisement database for first number information and second number information recorded in association with the advertiser.

“The first number information” is information on the first number of times that the advertisement identifier may be allocated to answer information inputted by the advertiser. ‘The second number information’ is information on the second number of times that the advertisement identifier has been allocated to answer information inputted by the advertiser. For example, in case that the first number information associated with the advertiser is ‘100 times’ and the second number information is ‘50 times’, it means that 50 advertising answer information has been generated in association with the advertiser and 50 advertising answer information may be further generated.

In the step 315, the knowledge advertising system determines whether the second number of times is less that the first number of times by using the searched first number information and second number information.

In case that it is determined that the second number of times is less than the first number of times, the knowledge advertising system allocates the advertisement identifier to the answer information in the step 316.

In case that it is determined that the second number of times is same to the first number of times, the knowledge advertising system may notify the advertiser that the advertisement identifier may not be allocated to the answer information and recommend the advertiser to pay additional advertisement costs (first fee) and update the first number information or the second number information. That is, the knowledge advertising system may recommend the advertiser to make a recontract of advertisement. For example, the advertiser may request the knowledge advertising system to update the first number information to ‘200’ and the second number information to ‘0’ and in correspondence to the updating, may pay an additional first fee.

Furthermore, according to another embodiment of the present invention, an authority of enabling an advertiser to generate advertising answer information may be given to the advertiser only the predetermined number of times (a first number of times) during a predetermined period (until an expiration time passes).

In the step 318, the knowledge advertising system provides users with the generated advertising answer information through the wired/wireless communication network, in association with the question information. At this time, the advertising answer information may be provided for users by a method different from that of providing general answer information without the advertisement identifier, in order to enhance advertising effects.

For example, the advertising answer information may be displayed in a different location from a location of general answer information, on a web browser. Namely, the advertising answer information may be placed in the highest location or the location where banner advertisements are generally displayed.

In addition, the advertising answer information may be displayed in a type different from the general answer information. According to each embodiment, the advertising answer information may include a flash, a moving picture, an image, and the like. In addition, the advertising answer information may include an audio file and provide a user referring to the advertising answer information with music, a voice advertisement, and the like.

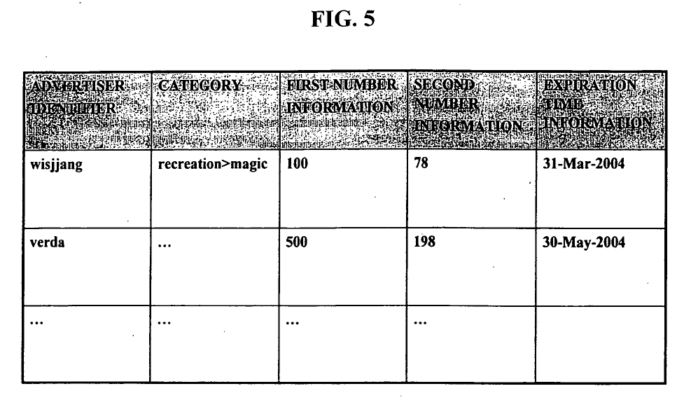

FIG. 6 is a view illustrating one example of advertising answer information provided for a user.

In the meantime, according to each embodiment, the knowledge service system providing the knowledge service enables predetermined answer information to be adopted from answer information inputted in association with the question information. It is general that answer information regarded to be most appropriate with respect to the question information is adopted. The answer information may be adopted by a selection of the questioner, votes of users who have referred to the question information and the answer information, or the like. Expression preference of the adopted answer information is higher than that of unadopted answer information.

According to another embodiment of the present invention, the knowledge advertising system displays answer information in order of adopted answer information, advertising answer information, and general answer information.

Namely, in an aspect of expression preference, advertising answer information for advertising is also expressed in a lower rank than the adopted answer information. Therefore, there is an effect that the advertiser prepares answer information included in advertising answer information more faithfully so that his/her advertising answer information may be adopted to be displayed in a better location.

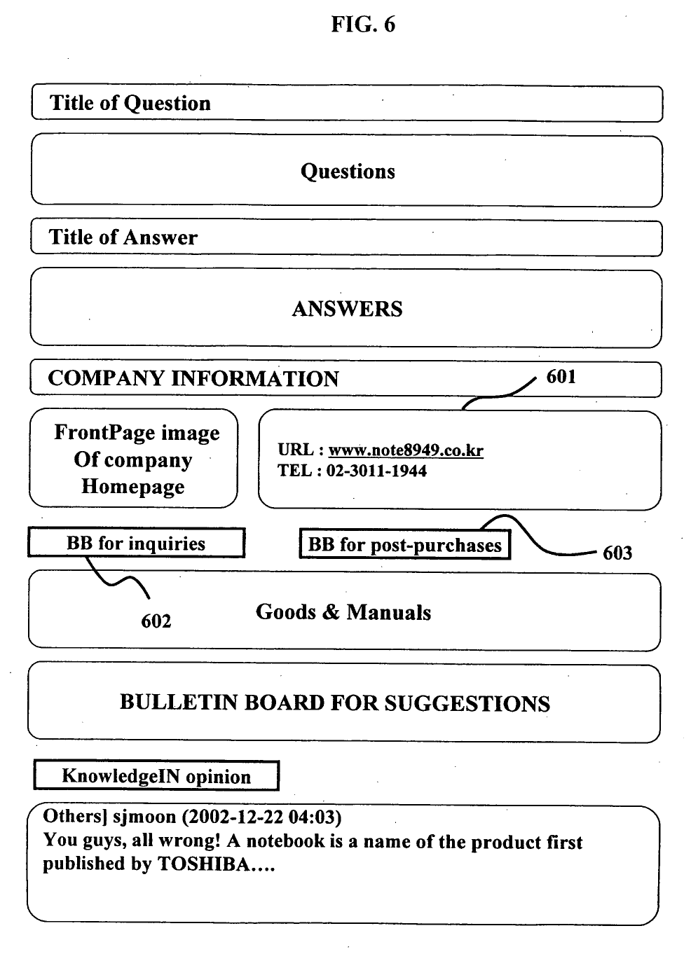

Hereinafter, procedures of performing the step 301 according to another embodiment of the present invention will be further fully described with reference to FIG. 7.

In the step 701, the knowledge advertising system receives a selection of a category from an advertiser who wants to perform advertising by using advertising answer information. The knowledge advertising system may provide the advertiser with an interface enabling the advertiser to select a wanted category by sequentially selecting the category from higher categories to lower categories, such that the advertiser may select the category easily.

In the step 702, the knowledge advertising system records an advertiser identifier with respect to the advertiser in a knowledge advertisement database in association with the selected category and registers the advertiser to the knowledge advertisement database.

The knowledge advertising system enables the advertiser to generate advertising answer information by referring to the knowledge advertisement database. Namely, the knowledge advertising system enables an advertisement using advertising answer information and, in the steps 703 to 707, controls a first fee to be charged the advertiser with respect to registration thereof to the knowledge advertisement database (first charging).

Meanwhile, a variety of methods as follow may be employed to determine the first fee.

According to one embodiment of the present invention, the knowledge advertising system computes an activation degree of the category selected by the advertiser and determines the first fee by using the computed activation degree.

According to each embodiment, the activation degree of the category may be computed by variety of methods. The knowledge advertising system may compute the activation degree by using an access number which is the number of times that users access the web page of the selected category.

Furthermore, the knowledge advertising system may compute the activation degree by using the number of question information inputted in association with the category, the number of answer information inputted in association with the question information, and the average reference number of users with respect to question information provided in association with the category.

Furthermore, the knowledge advertising system may compute the activation degree by using an average answer number computed by using the number of question information inputted in association with the category and the number of answer information inputted in association therewith.

The knowledge advertising system may determine the first fee to be higher with respect to the advertiser who has selected a category of which the activation degree is high, by using the computed activation degree as above.

Furthermore, according to another embodiment of the present invention, the knowledge advertising system may determine the first fee based on a period that the advertiser may generate advertising answer information, i.e. based on an advertising period.

In the step 704, the knowledge advertising system records expiration time information in the knowledge advertisement database, in association with the advertiser. As described above, the knowledge advertising system determines whether it is within the period that the advertiser may generate advertising answer information, i.e. within the advertising period. In case that the advertising period has expired, the knowledge advertising system does not generate advertising answer information. The knowledge advertising system may determine the first fee differently by using the expiration time information, i.e. according to the advertising period. For example, the longer the advertising period, the higher the first fee is determined.

Namely, the knowledge advertising system may determine the first fee by using at least one of the activation degree of the selected category (x1), the advertising period that the advertiser may generate the advertising answer information (associated with the expiration time information (x2)), and the number of times that the advertiser may generate the advertising answer information (associated with the first number information (x3)).

In the step 707, the knowledge advertising system controls the determined first fee to be charged the advertiser.

Furthermore, according to another embodiment of the present invention, in case that advertising answer information inputted by the advertiser is adopted by a questioner who has inputted the question information, the knowledge advertising system provides the advertiser with a predetermined point. The knowledge advertising system may induce the advertiser to give a faithful and appropriate answer to the question information by providing the point for the advertiser who has inputted the adopted advertising answer information. According to configuration so constructed, there is an effect that it is possible to enhance quality of the knowledge service provided by the knowledge advertising system.

The knowledge advertising system may enable the advertiser to use the point in order to extend the expiration time or increase the first number of times, or in case that the advertiser makes a recontract of advertisement, may enable the advertiser to use the point in order to get discount with respect to the first fee. In addition, in case that the knowledge advertising system provides a keyword advertising service, particularly in case that the knowledge advertising system provides a keyword advertisement in the knowledge service, or in case that a keyword (search word) associated with knowledge information including the advertising answer information is received from a user, the point may be used to increase expression preference of the knowledge information. Moreover, the point may be used to pay advertisement costs for using the keyword advertising service. Like above, the knowledge advertising system may provide a variety of methods of using points, such that the advertiser inputs high quality advertising answer information and quality of the entire knowledge service is improved.

Furthermore, according to another embodiment of the present invention, in case that the user who has referred to the advertising answer information links to a predetermined web page by using the advertising answer information, the knowledge advertising system controls a second fee to be charged the advertiser with respect to providing of the link. Hereinafter, this will be fully described.

The advertising answer information includes link information for linking to the predetermined web page. A URL of the web page may be used as for the link information. A user provided with the advertising answer information may access the web page by clicking (a link request) a predetermined phrase or an image, which is linked to the web page, in the step 708. In response to the click, the knowledge advertising system relays such that the user accesses the web page (step 709).

The web page may be a profile page which is a web page providing personal information associated with the advertiser, a sale page which is a web page maintained by the advertiser for selling goods or services, a bulletin board for inquiries, a bulletin board for post-purchases, and the like. Drawings symbols 601 to 603 indicate links to the sale page, the bulletin board for inquiries, and the bulletin board for post-purchases, respectively.

In addition, the profile page of the advertiser may be provided in a type different from that of general user. For example, an advertising phrase or an advertising moving picture may be provided in the profile page of the advertiser for advertising effects, or an interface may be included therein for a link to a predetermined sale page.

According to another embodiment of the present invention, the knowledge advertising system enables the advertiser to select a web page to be linked through the advertising answer information.

The knowledge advertising system controls the second fee to be charged the advertiser with respect to providing of the link enabling a link to the web page through the advertising answer information (step 711).

According to another embodiment of the present invention, the knowledge advertising system counts the linked number whenever the link is provided for the user (step 710) and determines the second fee based on the linked number.

Furthermore, according to another embodiment of the present invention, in case that the user who has accessed the web page through the advertising answer information purchases goods or services, the knowledge advertising system charges the advertiser a third fee with respect to the purchase. The third fee may be determined based on the number of times that the user who has accessed the sale page purchases goods or services.

Furthermore, according to another embodiment of the present invention, the advertiser may retrieve the advertisement identifier from the advertising answer information. The advertiser selects advertising answer information associated with oneself and inputs a request for retrieval of the advertisement identifier allocated to the advertising answer information, in the knowledge advertising system. In response thereto, the knowledge advertising system retrieves the advertisement identifier from the advertising answer information, changes the advertising answer information into general answer information, and provides users with the general answer information by a method of providing general answer information.

In the meantime, in case that the first number of times that the advertiser may generate advertising answer information is determined, the knowledge advertising system updates the second number of times recorded in association with the advertiser and records the updated second number of times in the knowledge advertising system. Namely, due to retrieval of the advertisement identifier, the second number of times is reduced. According to configuration so constructed, in a state where the first number of times is limited, in case that the advertiser operates an advertisement using advertising answer information, the advertiser has the wider range of selections. For example, the advertiser may retrieve the advertisement identifier from unadopted advertising answer information and generate advertising answer information with respect to new question information.

Furthermore, according to another embodiment of the present invention, even in case that the advertiser requests the knowledge advertising system to retrieve the advertisement identifier and thereby, the advertising answer information is changed into general answer information, the knowledge advertising system may not decrease the second number of times.

Furthermore, according to another embodiment of the present invention, in case that advertising answer information includes a content corresponding to a predetermined violation reason, the knowledge advertising system may retrieve the advertisement identifier from the advertising answer information. The violation reason includes any one between that an answer included in the advertising answer information includes an unsound content against social ideas and that the answer is unfaithful.

According to each embodiment, the knowledge advertising system may increase a violation point in association with the advertising answer information whenever the violation reason occurs, and may retrieve the advertisement identifier only when the violation point exceeds a predetermined value.

In case that the advertisement identifier is retrieved, the advertising answer information is changed into general answer information and provided for users by a method of providing general answer information.

Retrieval of the advertisement identifier is a kind of punishment to the advertiser who has generated advertising answer information including unfaithful and unsound contents. Thus, even in case that the advertisement identifier is retrieved, the knowledge advertising system may not update the second number information

Meanwhile, the aforementioned embodiment describes that the advertiser is enabled to generate advertising answer information by each category. However, according to another embodiment of the present invention, the knowledge advertising system may enable the advertiser to generate advertising answer information with respect to question information belonging to “a random” category.

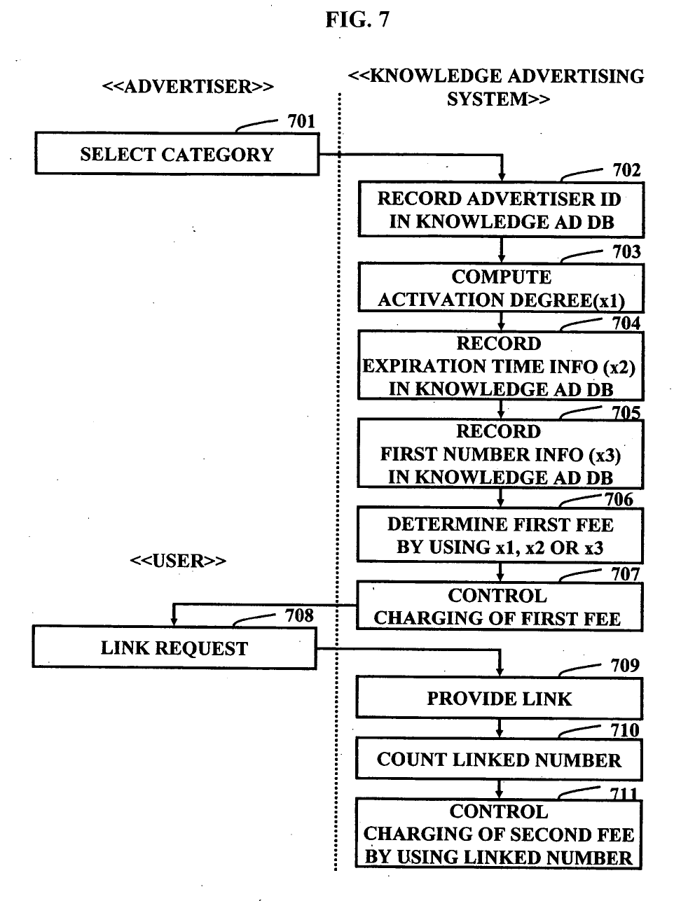

Hereinafter, a knowledge advertising system according to another embodiment of the present invention will be described with reference to FIG. 8.

A knowledge advertising system 800 comprises a knowledge advertisement database 801, a knowledge service server 802, an advertising answer information generating module 803, a database management module 804, a charging module 805, and a knowledge database 806.

The knowledge advertisement database 801 records a category and an advertiser identifier associated with the category. One example of the knowledge advertisement database 801 is illustrated in FIG. 8.

The knowledge service server 802 records and maintains question information received from a questioner in the knowledge database 806 by each category and provides users with the question information.

In addition, the knowledge service server 802 receives answer information with respect to the question information from an answerer. The knowledge service server 802 determines whether the answerer is an advertiser by referring to the knowledge advertisement database 801.

In case that it is determined that the answerer is not an advertiser, i.e. in case that the answer information is general answer information, the knowledge service server 802 records and maintains the general answer information in the knowledge database 806 in association with the question information, and provides users with the general answer information in association with the question information.

In case that it is determined that the answerer is an advertiser, the knowledge service server 802 notifies the fact to the advertising answer information generating module 803. The advertising answer information generating module 803 receives the notification, searches for a second category associated with the advertiser by referring to the knowledge advertisement database 801, and determines whether the first category is identical to the searched second category. At this time, the question information belongs to the first category.

In case that it is determined that the first category is not identical to the searched second category, the knowledge service server 802 records and maintains the answer information in the knowledge database 806 as general answer information and provides users with the general answer information in association with the question information.

In case that it is determined that the first category is identical to the searched second category, the advertising answer information generating module 803 allocates an advertisement identifier to the answer information, thereby generating advertising answer information.

The knowledge service server 802 provides users with the generated advertising answer information by a method different from that of providing general answer information. For example, the generated advertising answer information may be placed in a higher location than a location of general answer information, provided in a different type from general answer information, or provided in a type of banner.

A user who wants to advertise using advertising answer information inputs a selection of a category into the knowledge advertising system 800. The database management module 804 records an advertiser identifier with respect to the user (the advertiser) in the knowledge advertisement database 801, in association with the selected category.

The charging module 802 records the advertiser identifier in the knowledge advertisement database 801 and controls a first fee to be charged the advertiser with respect to generation of advertising answer information.

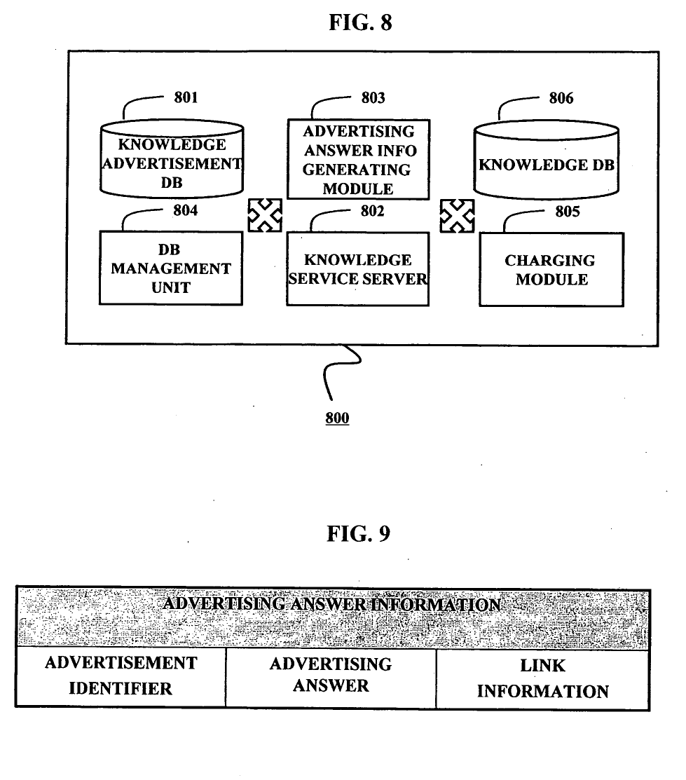

According to another embodiment of the present invention, the advertising answer information includes link information with respect to a predetermined web page, for example, a bulletin board for inquiries, a bulletin board for post-purchases, a profile page, a sale page of the advertiser, etc. Namely, advertising answer information includes an advertising answer, an advertisement identifier, link information, and the like, as illustrated in FIG. 9.

A user provided with the advertising answer information requests the knowledge service server 802 to link to the predetermined web page by using link information included in the advertising answer information. In this case, the knowledge service server 802 relays such that the user accesses the web page using the link information.

At this time, the charging module 805 may control a second fee to be charged the advertiser with respect to providing of the link and the second fee may be determined based on the number of times that the link is provided.

The embodiments of the present invention include computer readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts.

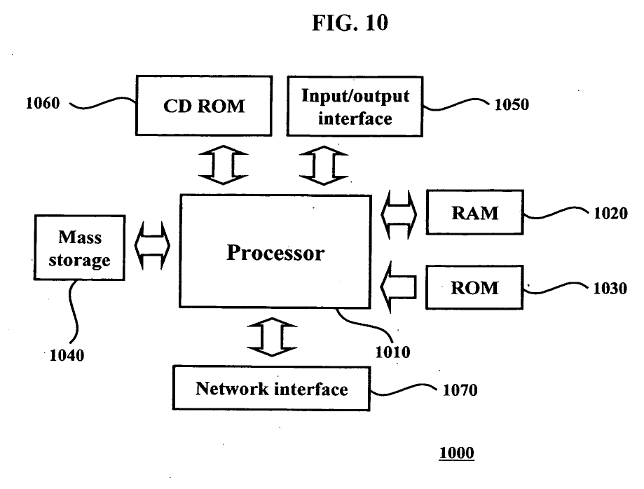

FIG. 10 is an internal block diagram of a general-purpose computer which can be more adopted in implementing the knowledge advertising method according to the present invention.

The computer system 1000 includes any number of processors 1010 (also referred to as central processing units, or CPUs) that are coupled to storage devices including primary storage (typically a random access memory, or “RAM 1020”), primary storage (typically a read only memory, or “ROM 1030”). As is well known in the art, ROM 1030 acts to transfer data and instructions uni-directionally to the CPU and RAM 1020 is used typically to transfer data and instructions in a bi-directional manner. Both of these primary storage devices may include any suitable type of the computer-readable media described above. A mass storage device 1040 is also coupled bi-directionally to CPU and provides additional data storage capacity and may include any of the computer-readable media described above. The mass storage device 1040 may be used to store programs, data and the like and is typically a secondary storage medium such as a hard disk that is slower than primary storage. A specific mass storage device such as a CD-ROM 1060 may also pass data uni-directionally to the CPU. Processor 1010 is also coupled to an interface 1050 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1010 optionally may be coupled to a computer or telecommunications network using a network connection as shown generally at a network interface 1070. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of this invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

According to the present invention, there are provided a knowledge advertising method and a knowledge advertising system associated with a knowledge service, i.e. the knowledge advertising method and the knowledge advertising system, enabling answerers to give advertising answers including predetermined advertising information with respect to questions inputted by users in the knowledge service.

Also, according to the present invention, there are provided a knowledge advertising method and a knowledge advertising system, capable of enhancing attention of users by providing users the advertising answers by a method different from that of providing a general answer.

Also, according to the present invention, there are provided a knowledge advertising method and a knowledge advertising system, capable of giving an advertiser a right to give an advertising answer and charging the advertiser advertisement costs with respect to the grant of the right.

Also, according to the present invention, there are provided a knowledge advertising method and a knowledge advertising system, enabling an advertiser to give an advertising answer during a certain period or as many as a certain number of times.

Also, according to the present invention, there are provided a knowledge advertising method and a knowledge advertising system, capable of determining the advertisement costs based on the certain period or the certain number of times.

Also, according to the present invention, there are provided a knowledge advertising method and a knowledge advertising system, capable of giving a right for giving an advertiser an advertising answer in accordance with each category.

Also, according to the present invention, there are provided a knowledge advertising method and a knowledge advertising system, capable of measuring an activation degree of a category, i.e. preferences of users with respect to the category and determining the advertisement costs in accordance with the measured activation degree.

Also, according to the present invention, there are provided a knowledge advertising method and a knowledge advertising system, capable of controlling users to be linked to a predetermined webpage through the advertising answer and charging the advertiser advertisement costs with respect to providing of the link.

Also, according to the present invention, there are provided a knowledge advertising method and a knowledge advertising system, capable of determining the advertisement costs with respect to providing of the link on the basis of a link number, which is a number of times that a user accesses the webpage through the advertising answer.

What is claimed is:

1. A knowledge advertising method using a knowledge service, the method comprising:
providing a knowledge advertisement database comprising a plurality of knowledge advertisement records, wherein each knowledge advertisement record is associated with a registered advertiser, wherein each knowledge advertisement record comprises a designated category and an advertiser identifier, the plurality of knowledge advertisement records comprising a first knowledge advertisement record associated with a first registered advertiser, and wherein the first knowledge advertisement record comprises a first designated category and a first advertiser identifier;
posting questions and receiving answers to posted questions via a wired or wireless communication network, wherein each question is associated with a category;
receiving from a terminal associated with the first registered advertiser a first answer to a first question associated with a first category;
determining whether the first category is identical to the first designated category;
allocating the first advertiser identifier to the first answer; and
posting the first answer with the first advertiser identifier via the wire or wireless communication network.

2. The method of claim 1, wherein answers to which an advertiser identifier is allocated are posted with privileges that answers without an advertiser identifier are not entitled to.

3. The method of claim 2, wherein the privileges of answers with an advertiser identifier comprises being displayed in a designated area of a screen, and wherein answers without an advertiser identifier are not displayed in the designated area.

4. The method of claim 2, wherein the privileges of answers with an advertiser identifier comprises being displayed with a special effect.

5. The method of claim 1, wherein the first advertiser identifier is allocated to the first answer if the first registered advertiser selects to allocate the first advertiser identifier to the first answer.

6. The method of claim 1, wherein the first knowledge advertisement record further comprises a total number of times the first advertiser identifier can be allocated to answers from the first registered advertiser and a current number of times the first advertiser identifier has been allocated to answers from the first registered advertiser; and wherein the first advertiser identifier is allocated to the first answer only if the current number is smaller than the total number.

7. The method of claim 6, further comprising:
receiving from the terminal associated with the first registered advertiser a request to remove the first advertiser identifier from the first answer after posting the first answer with the first advertiser identifier reducing the current number by one in the first knowledge advertisement record; and
posting the first answer without the first advertiser identifier.

8. The method of claim 6, further comprising charging to the first registered advertiser a fee for the allocation of the first advertiser identifier, wherein the fee is determined using the total number of times.

9. The method of claim 6, wherein the first knowledge advertisement record further comprises an expiration time thereof; and wherein the method further comprises:
determining that the knowledge advertisement record is expired by referring to the expiration time; and
removing the first knowledge advertisement record from the knowledge advertisement database.

10. The method of claim 1, wherein the first knowledge advertisement record further comprises an expiration time thereof, and wherein the first advertiser identifier is allocated to the first answer if the expiration time of the first knowledge advertisement record has not passed.

11. The method of claim 1, further comprising screening for offensive contents or incorrect answers in the first answer prior to allocating the first advertiser identifier to the first answer.

12. The method of claim 1, wherein the first knowledge advertisement record further comprises an expiration time of a contract with the first registered advertiser; and wherein the first answer is provided without the first advertiser identifier if the contract has expired.

13. The method of claim 1, further comprising allocating an expiration time to the first answer, and wherein the first answer is provided without the first advertiser identifier if the first answer has expired.

14. The method of claim 1, further comprising charging to the first registered advertiser a fee for the allocation of the first advertiser identifier based on popularity of the first designated category.

15. The method of claim 14, wherein the popularity of the first designated category is computed using at least one selected from the group consisting of: the number of times that users access webpages of the knowledge service that are associated with the designated category, the number of posted questions that are associated with the first designated category, the number of answers to posted questions associated with the first designated category, an average number of users who access questions associated with the first selected category, and an average answer rate which is a ratio of the number of questions associated with the first designated category to the number of answers associated with the first designated category.

16. The method of claim 1, wherein the first knowledge advertisement record further comprises an expiration time thereof; and wherein the method further comprises:
posting the first answer without the first advertiser identifier if the expiration time has passed; and
charging to the first registered advertiser a fee associated with the allocation of the first advertiser identifier based on the expiration time of the first knowledge advertisement record.

17. The method of claim 1, further comprising:
receiving a rating for the first answer; and
providing points to the first registered advertiser using the rating of the first answer.

18. The method of claim 1, wherein the first answer further comprises an operative link to a webpage associated with a business of the registered advertiser; and the method further comprising:
monitoring use of the link to open the webpage by users of the knowledge service who have received the first answer; and
charging to the registered advertiser a fee based on use of the link by users.

19. The method of claim 18, wherein charging to the registered advertiser comprises:
computing the number of times users of the knowledge service use the link to access the webpage; and
determining the fee based on the number.

20. A computer-readable medium storing instructions when executed perform a method comprising:
providing a knowledge advertisement database comprising a plurality of knowledge advertisement records, wherein each knowledge advertisement record is associated with a registered advertiser, wherein each knowledge advertisement record comprises a designated category and an advertiser identifier, the plurality of knowledge advertisement records comprising a first knowledge advertisement record associated with a first registered advertiser, and wherein the first knowledge advertisement record comprises a first designated category and a first advertiser identifier;
communicating posted questions and receiving answers to posted questions via a wired or wireless communication network, wherein each question is associated with a category;
receiving from a terminal associated with the first registered advertiser a first answer to a first question associated with a first category;
determining whether the first category is identical to the first designated category;
allocating the first advertiser identifier to the first answer; and
posting the first answer with the first advertiser identifier via the wire or wireless communication network.

21. A knowledge advertising system using a knowledge service, the system comprising:
a knowledge service module posting questions and answers to posted questions via a wired or wireless communication network, each question be associated with a category; and
an advertisement answer module allocating an advertiser identifier of a registered advertiser to an answer from the registered advertiser if the category associated with the question is identical to a designated category of the registered advertiser.

22. The system of claim 21, further comprising a display module posting the answer with the advertiser identifier different from answers without an advertiser identifier.

23. The system of claim 21, further comprising a knowledge advertisement database comprising an advertisement record associated with the registered advertiser, the advertisement record comprises the advertiser identifier for identifying the registered advertiser and the designated category of the registered advertiser.

24. The system of claim 23, further comprising:
a database management module managing the knowledge advertisement database and configured to update the contents of the knowledge advertisement database; and
a fee module charging registered advertisers a fee for the allocation of an advertiser identifier to answers from a terminal associated with registered advertisers.

25. The system of claim 24, wherein an answer from a terminal associated with a registered advertiser comprises a link to a webpage on a business of a registered advertiser who provides the answer; wherein the knowledge service module is further configured to receive a request to open the link from a user; and wherein the charging module is further configured to charge to the registered advertiser a fee associated with use of the link by the user.

26. An advertising method comprising:
receiving a question from a first user, wherein the question is associated with a category and is viewable by a plurality of users;
receiving an answer to the question from an advertiser; and
providing to the first user and a plurality of users the answer from the advertiser, and further providing an advertisement from the advertiser associated with the answer if a category associated with the advertiser is identical to the category associated with the question.

27. An advertising system comprising:
a question module configured to receive a question from a first user, wherein the question is associated with a category and is viewable by a plurality of users;
an answer module configured to receive an answer to the question from an advertiser; and
an advertising module configured to provide to the first user and a plurality of users the answer from the advertiser, and further configured to provide an advertisement from the advertiser associated with the answer if a category associated with the advertiser is identical to the category associated with the question.

28. An advertising system comprising:
means for receiving a question from a first user, wherein the question is associated with a category and is viewable by a plurality of users;
means for receiving an answer to the question from an advertiser; and
means for providing to the first user and a plurality of users the answer from the advertiser, and further providing an advertisement from the advertiser associated with the answer if a category associated with the advertiser is identical to the category associated with the question.
